(19) United States
(12) Patent Application Publication
(10) Pub. No.: US 2008/0059163 A1
(43) Pub. Date: Mar. 6, 2008

(54) METHOD AND APPARATUS FOR NOISE SUPPRESSION, SMOOTHING A SPEECH SPECTRUM, EXTRACTING SPEECH FEATURES, SPEECH RECOGNITION AND TRAINING A SPEECH MODEL

(75) Inventors: Pei Ding, Don Cheng District (CN); Lei He, Don Cheng District (CN); Jie Hao, Don Cheng District (CN)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/758,855

(22) Filed: Jun. 6, 2007

(30) Foreign Application Priority Data
Jun. 15, 2006 (CN) 200610092246.1

(51) Int. Cl. G10L 21/02; G10L 15/00

(52) U.S. Cl. 704/226; 704/251; 704/E15.001

(57) ABSTRACT

The present invention provides a method and apparatus for noise suppression, smoothing a speech spectrum, extracting speech features, speech recognition and training a speech model. Said method of noise suppression is performed by minimum mean-square error estimation, wherein the confluent hyper-geometric function is approximated by a piece-wise linear function, which greatly decreases the computation load while maintains the noise-reduction performance. Moreover, to avoid producing the frequency components of extremely low energy, the present invention smoothes the speech spectrum both in time and frequency axis with geometric sequence weights after minimum mean-square error estimation. Moreover, the present invention balances noise suppression and speech distortion by adjusting the a priori signal-noise-rate.

### CROSS-REFERENCE TO RELATED APPLICATIONS

This application is based upon and claims the benefit of priority from prior Chinese Patent Application No. 200610092246.1, filed on Jun. 15, 2006; the entire contents of which are incorporated herein by reference.

### TECHNICAL FIELD

The present invention relates to technology of speech recognition and noise suppression, and technology for smoothing a speech spectrum.

### TECHNICAL BACKGROUND

Prevailing automatic speech recognition (ASR) systems can obtain very high accuracy for clean speech recognition, but their performance will degrade dramatically in noisy environments owing to the mismatch between the acoustic models and the acoustic features.

Most of the efforts made for noise robustness issue are concentrated on front-end design, in which the aim is to reduce the mismatch in speech feature space. Minimum mean-square error (MMSE) estimation is a speech enhancement algorithm which can effectively suppress the background noise, and consequently improve the signal-to-noise ratio (SNR) of the input signal. The minimum mean-square error estimation has been described in detail, for example, in the article “Speech enhancement using a minimum mean-square error short-time spectral amplitude estimator”, Y. Ephraim and D. Malah, IEEE Trans. Acoustic, Speech, and Signal Processing, Vol. ASSP-32, pp. 1109-1121, 1984. In the article, Short-Time Spectral Amplitude (STSA) is estimated with the MMSE estimation, and a system which estimates with MMSE STSA is proposed, and this system is compared with the widely used system based on Wiener filter and Spectral Subtraction Algorithm. All of which are incorporated herein by reference.

Applying MMSE estimation in front-end is a promising method to improve the robustness. However, three problems need to be solved in above framework.

1. The calculation of confluent hyper-geometric function (calculated by Taylor series accumulation) leads to a huge computation load.

2. Extremely low energy in frequency bands incurred by over-reduction of interfering noise will cause recognition performance degradation.

3. The strategy in MMSE estimation is usually not optimum for speech recognition.

### SUMMARY OF THE INVENTION

In order to solve the above-mentioned problems in the prior technology, the present invention provides a method and apparatus for noise suppression, smoothing a speech spectrum, extracting speech features, speech recognition and training a speech model.

According to an aspect of the present invention, there is provided a method of noise suppression for a noise-included speech spectrum, comprising: performing minimum mean-square error estimation on the noise-included speech spectrum with a noise estimation spectrum, to reduce noise of the noise-included speech spectrum; wherein the confluent hyper-geometric function is replaced with a piece-wise linear function to perform the minimum mean-square error estimation.

According to another aspect of the present invention, there is provided a method of noise suppression for a noise-included speech spectrum, comprising: performing minimum mean-square error estimation on the noise-included speech spectrum with an a priori signal-noise-rate to reduce noise of the noise-included speech spectrum; and adjusting the a priori signal-noise-rate to obtain proper noise suppression.

According to another aspect of the present invention, there is provided a method for smoothing a speech spectrum, comprising: calculating a weight average of energies of each spectral component of the speech spectrum and its neighboring spectral components with geometric series weights; and adjusting the energy of the spectral component with the weight average calculated.

According to another aspect of the present invention, there is provided a method for extracting speech features, comprising: transforming a noise-included speech to a noise-included speech spectrum; reducing noise of the noise-included speech spectrum by using the above-mentioned method of noise suppression; and extracting speech features from the noise-reduced speech spectrum.

According to another aspect of the present invention, there is provided a method for extracting speech features, comprising: transforming a speech to a speech spectrum; smoothing the speech spectrum by using the above-mentioned method for smoothing a speech spectrum; and extracting speech features from the smoothed speech spectrum.

According to another aspect of the present invention, there is provided a method of speech recognition, comprising: extracting speech features from a speech by using the above-mentioned method for extracting speech features; and recognizing the speech based on the speech features extracted.

According to another aspect of the present invention, there is provided a method for training a speech model, comprising: extracting speech features from a speech by using the above-mentioned method for extracting speech features; and training the speech model based on the speech features extracted.

According to another aspect of the present invention, there is provided a method of speech recognition, comprising: transforming a noise-included speech to a noise-included speech spectrum; reducing noise of the noise-included speech spectrum by using the above-mentioned method of noise suppression; extracting the speech features from the noise-reduced speech spectrum; recognizing the noise-included speech based on the speech features extracted; and determining an optimum value of the a priori signal-noise-rate based on the result of speech recognition.

According to another aspect of the present invention, there is provided an apparatus of noise suppression for a noise-included speech spectrum, comprising: an estimation unit configured to perform minimum mean-square error estimation on the noise-included speech spectrum with a noise estimation spectrum to reduce noise of the noise-included speech spectrum; wherein the estimation unit is configured to replace a confluent hyper-geometric function with a piece-wise linear function to perform the minimum mean-square error estimation.

According to another aspect of the present invention, there is provided an apparatus of noise suppression for a noise-included speech spectrum, comprising: an estimation unit configured to perform minimum mean-square error estimation on the noise-included speech spectrum with an a priori signal-noise-rate to reduce noise of the noise-included speech spectrum; and an adjusting unit configured to adjust the a priori signal-noise-rate to obtain proper noise suppression.

According to another aspect of the present invention, there is provided an apparatus for smoothing a speech spectrum, comprising: a weight-averaging unit configured to calculate weight average of energies of each spectral component of the speech spectrum and its neighboring spectral components with geometric series weights; and a smooth-adjusting unit configured to adjust the energy of the spectral component with the weight average of energies of the spectral component and its neighboring spectral components calculated by the weight-averaging unit.

According to another aspect of the present invention, there is provided an apparatus for extracting speech features, comprising: a transforming unit configured to transform a noise-included speech to a noise-included speech spectrum; the above-mentioned apparatus of noise suppression configured to reduce noise of the noise-included speech spectrum; and an extracting unit configured to extract speech features from the noise-reduced speech spectrum.

According to another aspect of the present invention, there is provided an apparatus for extracting speech features, comprising: a transforming unit configured to transform a speech to a speech spectrum; the above-mentioned apparatus for smoothing a speech spectrum configured to smooth the speech spectrum; and an extracting unit configured to extract speech features from the smoothed speech spectrum.

According to another aspect of the present invention, there is provided an apparatus of speech recognition, comprising: the above-mentioned apparatus for extracting speech features configured to extract speech features; and a speech recognition unit configured to recognize the speech based on the speech features extracted.

According to another aspect of the present invention, there is provided an apparatus for training a speech model, comprising: the above-mentioned apparatus configured to extract speech features; and a model-training unit configured to train the speech model based on the speech features extracted.

According to another aspect of the present invention, there is provided an apparatus of speech recognition, comprising: a transforming unit configured to transform a noise-included speech to a noise-included speech spectrum; the above-mentioned apparatus of noise suppression configured to reduce noise of the noise-included speech spectrum; an extracting unit configured to extract speech features from the noise-reduced speech spectrum; a speech recognition unit configured to recognize the noise-included speech based on the speech features extracted; and a determination unit configured to determine an optimum value of the a priori signal-noise-rate according to the result of speech recognition.

### BRIEF DESCRIPTION OF THE DRAWINGS

It is believed that through following detailed description of the embodiments of the present invention, taken in conjunction with the drawings, above-mentioned features, advantages, and objectives will be better understood.

FIG. 1 is a flowchart showing a method of noise suppression according to an embodiment of the present invention;

FIG. 2A-2D show an example of procedures of setting segmentation points of a piece-wise linear function, wherein FIG. 2A shows a curve of a confluent hyper-geometric function, FIG. 2B shows a curve of the derivative of the confluent hyper-geometric function, FIG. 2C shows a curve of a difference between the confluent hyper-geometric function and the piece-wise linear function, and FIG. 2D shows a curve of the piece-wise linear function after segmentation;

FIG. 3 is a flowchart showing a method of noise suppression according to another embodiment of the present invention;

FIG. 4A-4C show an example of the balance between the noise suppression and the speech distortion, wherein FIG. 4A shows an initial MMSE enhanced spectrum without adjusting the a prior SNR, FIG. 4B shows a speech spectrum adjusted by reducing the a prior SNR, and FIG. 4C shows a speech spectrum adjusted by increasing the a prior SNR;

FIG. 5 is a flowchart showing a method for smoothing a speech spectrum according to another embodiment of the present invention;

FIG. 6A-6B show an example for smoothing a speech spectrum, wherein FIG. 6A shows the speech spectrum before smoothing, and FIG. 6B shows the speech spectrum after smoothing;

FIG. 7 is a flowchart showing a method for extracting speech features according to another embodiment of the present invention;

FIG. 8 is a flowchart showing a method for extracting speech features according to another embodiment of the present invention;

FIG. 9 is a flowchart showing a method of speech recognition according to another embodiment of the present invention;

FIG. 10 is a flowchart showing a method for training a speech model according to another embodiment of the present invention;

FIG. 11 is a flowchart showing a method of speech recognition according to another embodiment of the present invention;

FIG. 12 is a block diagram showing an apparatus of noise suppression according to an embodiment of the present invention;

FIG. 13 is a block diagram showing an apparatus of noise suppression according to another embodiment of the present invention;

FIG. 14 is a block diagram showing an apparatus for smoothing a speech spectrum according to another embodiment of the present invention;

FIG. 15 is a block diagram showing an apparatus for extracting speech features according to another embodiment of the present invention;

FIG. 16 is a block diagram showing an apparatus for extracting speech features according to another embodiment of the present invention;

FIG. 17 is a block diagram showing an apparatus of speech recognition according to another embodiment of the present invention;

FIG. 18 is a block diagram showing an apparatus for training a speech model according to another embodiment of the present invention; and

FIG. 19 is a block diagram showing an apparatus of speech recognition according to another embodiment of the present invention.

### DETAILED DESCRIPTION OF THE INVENTION

In order to understand the following embodiments readily, the principle of the minimum mean-square error estimation will be simply introduced firstly.

The minimum mean-square error (MMSE) estimation is a speech enhancement algorithm, and suppresses noise in a noise-included speech spectrum with an estimation spectrum of background noise. Specifically, the minimum mean-square error estimation is performed based on the following formula:

$$\begin{matrix}{\hat{A}}_{k} = C \frac{\sqrt{{υ}_{k}}}{{γ}_{k}} M ( {υ}_{k} ) {R}_{k} , wherein & ( 1 ) \\ {υ}_{k} = \frac{{ξ}_{k}}{1 + {ξ}_{k}} {γ}_{k} , & ( 2 )\end{matrix}$$

wherein Âₖ denotes the noise-reduced speech spectrum, Rₖ denotes the noise-included speech spectrum, C denotes a constant, ξₖ denotes an a priori signal-noise-rate obtained from the noise estimation spectrum, γₖ denotes an a posteriori signal-noise-rate obtained from the noise estimation spectrum and the noise-included speech spectrum, M(υₖ) denotes the confluent hyper-geometric function, and k denotes the kth spectral component. The specific detail can be seen in the article of Y Ephraim and D. Malah.

Next, a detailed description of each embodiment of the present invention will be given in conjunction with the accompany drawings.

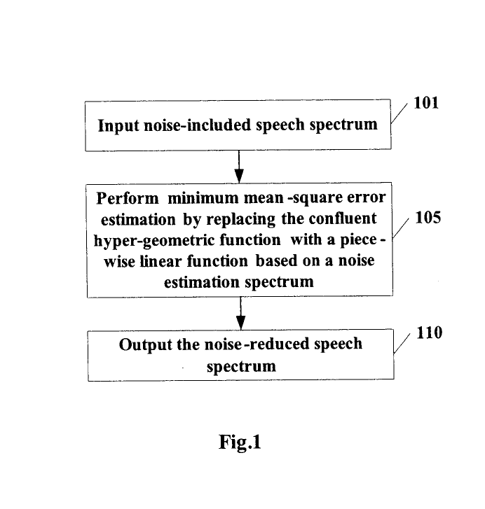

FIG. 1 is a flowchart showing a method of noise suppression according to an embodiment of the present invention. As shown in FIG. 1, first at Step 101, a noise-included speech spectrum is inputted. The noise-included speech spectrum is a speech spectrum obtained by, for example, a fast Fourier transform based on voice data including background noise and a speech, therefore, it is a spectrum containing background noise and a speech.

Next, at Step 105, the noise-included speech is estimated with the minimum mean-square error estimation according to the pre-estimated noise estimation spectrum. The noise estimation spectrum is obtained by pre-estimating the background noise without a speech. There are many ways to obtain the noise estimation spectrum, for example, averaging the background noise spectrum collected for many times. Specifically, the minimum mean-square error estimation is performed according to the formula (1) and (2), wherein the confluent hyper-geometric function is replaced with a piece-wise linear function, the formula after transform is:

$${\hat{A}}_{k} = C \frac{\sqrt{{υ}_{k}}}{{γ}_{k}} L ( {υ}_{k} ) {R}_{k} , \qquad ( 3 )$$

wherein Âₖ denotes the noise-reduced speech spectrum, Rₖ denotes the noise-included speech spectrum, C denotes a constant, υₖ is defined as the formula (2), ξₖ denotes an a priori signal-noise-rate obtained from the noise estimation spectrum, γₖ denotes an a posteriori signal-noise-rate obtained from the noise estimation spectrum and the noise-included speech spectrum, L(υₖ) denotes the piece-wise linear function, and k denotes the kth spectral component.

In this embodiment, the confluent hyper-geometric function M(υₖ) can be approximated with a piece-wise linear function L(υₖ) with a plurality of preset segmentation points. For example, the confluent hyper-geometric function M(υₖ) can be approximated with the piece-wise linear function L(υₖ) by following steps.

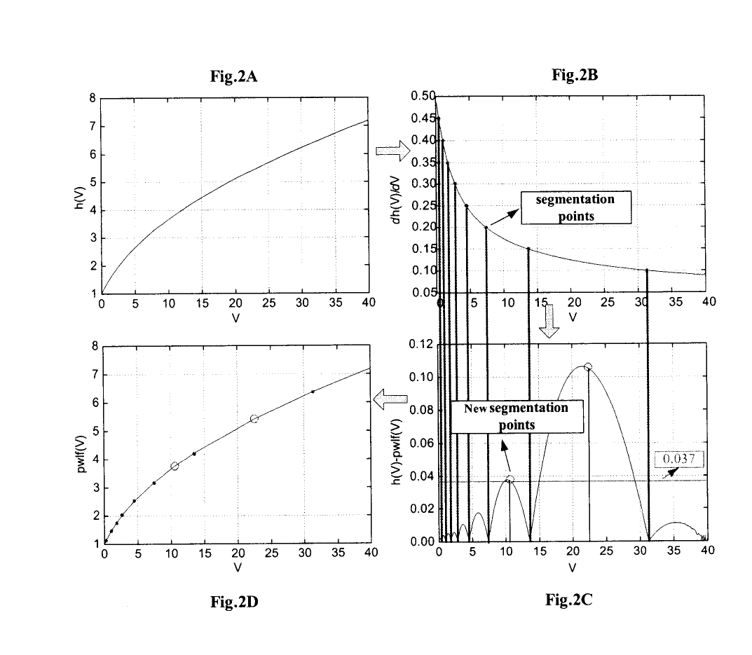

Specifically, FIG. 2A-2D shows an example of procedures of setting segmentation points of a piece-wise linear function, wherein FIG. 2A shows a curve h(v) of a confluent hyper-geometric function, FIG. 2B shows a curve of the derivative of the confluent hyper-geometric function, FIG. 2C shows a curve of a difference between the confluent hyper-geometric function and the piece-wise linear function, and FIG. 2D shows a curve pwlf(v) of the piece-wise linear function after segmentation.

First, the derivative of the confluent hyper-geometric function h(v) is calculated, as shown in FIG. 2B. In this example, only a curve in which the derivative value is within a range between 0.05 and 0.50 is selected as an example for convenience.

Next, initial segmentation points of the piece-wise linear function pwlf(v) are set, as shown in FIG. 2B. In this example, for example, the initial segmentation points are set at the derivative value of 0.10, 0.15, 0.20, 0.25, 0.30, 0.35, 0.40, and 0.45.

Next, the difference between the piece-wise linear function pwlf(v) and the confluent hyper-geometric function h(v) in between each two consecutive segmentation points of the initial segmentation points is calculated, as shown in FIG. 2C.

Next, the difference calculated between the values of two functions in between each two consecutive segmentation points is compared with a preset threshold, for example, in this embodiment, which is preset as 0.037. Through comparison, a new segmentation point will be inserted between the two consecutive segmentation points, for example, between 0.10 and 0.15, for example, at the middle point between them, if the difference is greater than 0.037,

The step of calculating the difference and the steps thereafter are repeated until no the difference is greater than the threshold. Thereby, the piece-wise linear function as shown in FIG. 2D is obtained.

Back to FIG. 1, the spectrum in which noise is reduced by MMSE estimation is outputted at Step 110 after performing the minimum mean-square error estimation with the piece-wise linear function pwlf(v) instead of the confluent hyper-geometric function h(v).

By using the method of noise suppression of the embodiment, the computation load of the MMSE estimation is greatly decreased while the noise-reduction performance is maintained by replacing the confluent hyper-geometric function with the piece-wise linear function.

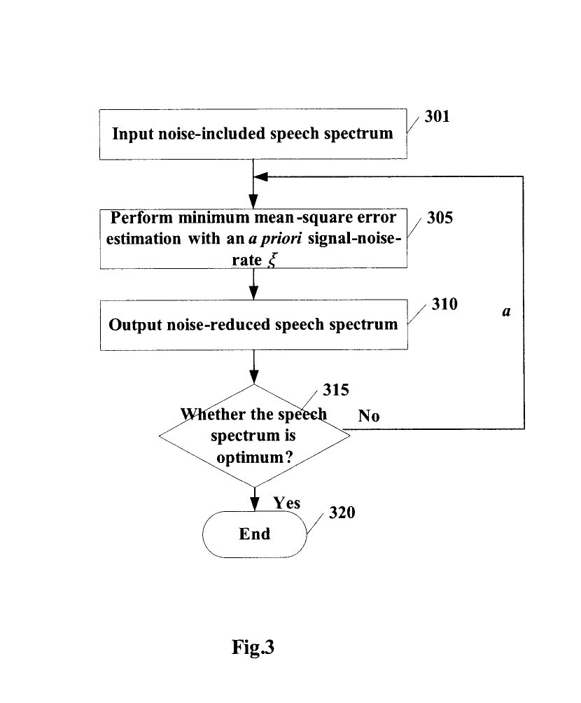

Under the same inventive conception, FIG. 3 is a flowchart showing a method of noise suppression according to another embodiment of the present invention. Next, the present embodiment will be described in conjunction with FIG. 3. For those same parts as the above embodiments, the description of which will be appropriately omitted.

As shown in FIG. 3, first at Step 301, a noise-included spectrum is inputted. The noise-included spectrum includes background noise and a speech.

Next, at Step 305, the minimum mean-square error estimation is performed on the noise-included speech. Specifically, in this embodiment, the minimum mean-square error estimation is performed by replacing the a priori signal-noise-rate ξ in the formula (2) with aξ, i.e., the minimum mean-square error estimation is performed with the formula (1) and (4):

$${υ}_{k} = \frac{a {ξ}_{k}}{1 + a {ξ}_{k}} {γ}_{k} \qquad ( 4 )$$

Similarly, in this embodiment, the minimum mean-square error estimation can be performed by replacing the confluent hyper-geometric function h(v) with the piece-wise linear function pwlf(v), i.e., the minimum mean-square error estimation is performed with the formula (3) and (4).

Next, at Step 310, a speech spectrum in which noise is reduced by MMSE estimation is outputted.

Next, at Step 315, it is determined whether the speech spectrum is optimum, i.e., whether the noise reduction and the speech distortion reach an optimum balance. If the speech spectrum is optimum, then the process is finished at Step 320. If not, the coefficient a is adjusted, the process is returned to Step 305 and the MMSE estimation is continuously performed until a proper result is obtained.

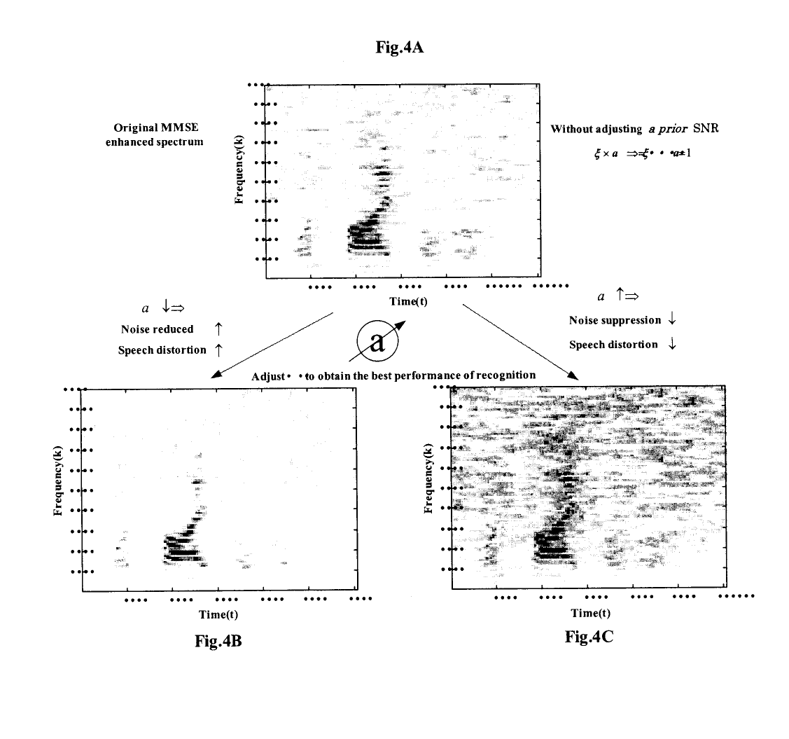

Specifically, FIG. 4A-4C show an example of the balance between the noise suppression and the speech distortion, wherein FIG. 4A shows an initial MMSE enhanced spectrum without adjusting the a prior SNR, FIG. 4B shows a speech spectrum adjusted by reducing the a prior SNR, and FIG. 4C shows a speech spectrum adjusted by increasing the a prior SNR.

It can be clearly seen in the drawing that the noise suppression and the speech distortion will increase if the coefficient a, i.e., the a prior signal-noise-rate ξ, is reduced, as shown in FIG. 4B. On the contrary, the noise suppression and the speech distortion will reduce if the coefficient a, i.e., the a prior signal-noise-rate ξ, is increased, as shown in FIG. 4C, wherein the basis used to determine if the adjustment is proper is the right ratio of recognition. If the ratio of recognition is bigger than the preset threshold, the adjustment is finished.

It can be known from the above description, the balance between the noise reduction and the speech distortion can be controlled because the method of noise suppression of the present invention can adjust the a prior signal-noise-rate ξ by replacing the a prior signal-noise-rate ξ with aξ, thereby a satisfactory result can be obtained.

Moreover, the method of noise suppression of the present embodiment can also use the piece-wise linear function in the above-mentioned method of noise suppression to replace the confluent hyper-geometric function so that the computation load of the MMSE estimation can be greatly decreased while the noise suppression performance can be maintained.

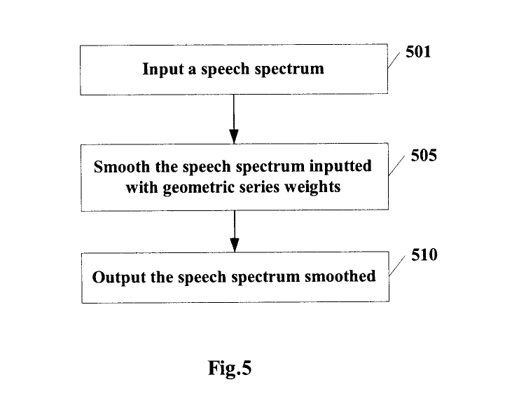

Under the same inventive conception, FIG. 5 is a flowchart showing a method for smoothing a speech spectrum according to another embodiment of the present invention. Next, the present embodiment will be described in conjunction with FIG. 5. For those same parts as the above embodiments, the description of which will be appropriately omitted.

As shown in FIG. 5, first at Step 501, a speech spectrum such as a pure speech spectrum, a noise-included speech spectrum in the above-mentioned embodiment, or a speech spectrum after the noise suppression through the above-mentioned embodiment, is inputted, and the embodiment has no special limitation to the speech spectrum.

Next, at Step 505, the speech spectrum inputted is smoothed with geometric series weights, wherein, for each spectral component of the speech spectrum, the energies of it and its neighboring spectral components are weight averaged as its energy, and the weights are geometric series weights.

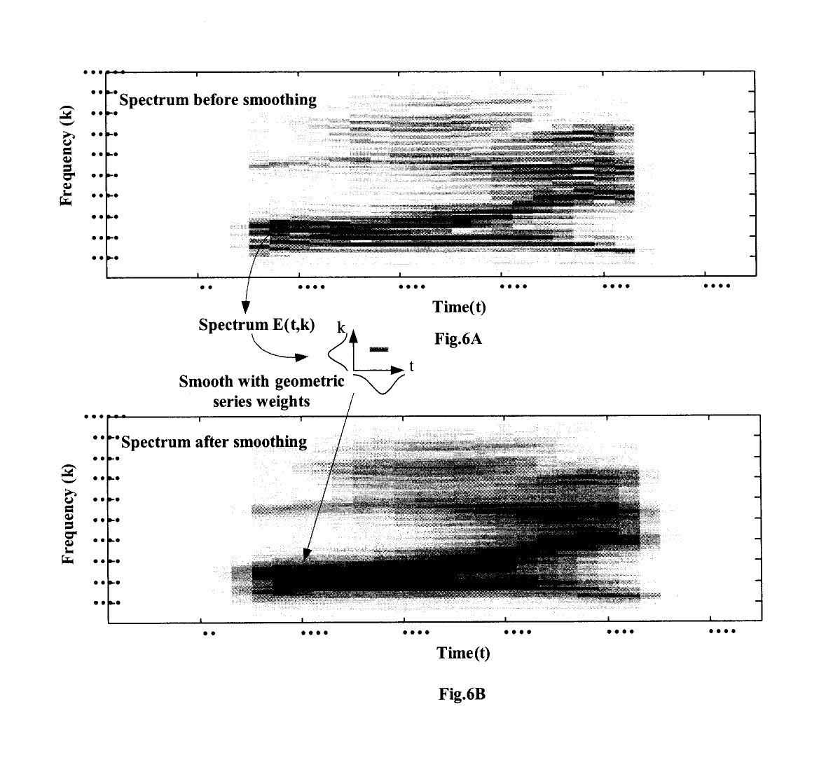

Specifically, FIG. 6A-6B shows an example for smoothing a speech spectrum, wherein FIG. 6A shows the spectrum before smoothing, and FIG. 6B shows the spectrum after smoothing. In FIG. 6A, for example, the spectral component E(10,30) where time t=10 and frequency k=30 is smoothed, wherein E(10,30) denotes the energy of the spectral component. The specific method for smoothing includes the following three ways:

(1) In time axis, i.e., for each frequency, the energies of each frame and its neighboring frames are weight averaged as the energy of the frequency and the frame. For example, for frequency k=30, the energy of the spectral component where frame t=10 is smoothed as:
E(10,30)=(E(10,30)×d₁+E(9,30)×d₂+E(11,30)×d₂+E(8,30)×d₃+E(12,30)×d₃+ . . . )/(d₁+2d₂+2d₃+ . . . )

Wherein d₁, d₂, d₃, . . . are step-down geometric series weights. The spectral components of other frames are smoothed in the same way.

(2) In frequency axis, i.e., for each frame, the energies of each frequency and its neighboring frequencies are weight averaged as the energy of the frequency and the frame. For example, for frame t=10, the energy of the spectral component where k=30 is smoothed as:
E(10,30)=(E(10,30)×d₁+E(10,29)×d₂+E(10,31)×d₂+E(10,28)×d₃+E(10,32)×d₃+ . . . )/(d₁+2d₂+2d₃+ . . . )

Wherein d₁, d₂, d₃, . . . are step-down geometric series weights. The spectral components of other frames are smoothed in the same way.

(3) At the same time, in time and frequency axis, the energies of each frequency and each frame and their neighboring frequencies and frames are weight averaged as the energy of the frame and the frequency. For example, the energy of the spectral component where frame t=10 and frequency k=30 is smoothed as:
E(10,30)=(E(10,30)×d₁+E(9,30)×d₂+E(11,30)×d₂+E(10,29)×d₂+E(10,31)×d₂+E(8,30)×d₃+E(12,30)×d₃+E(10,28)×d₃+E(10,32)×d₃+ . . . )/(d₁+4d₂+4d₃+ . . . )

Wherein d₁, d₂, d₃, . . . are step-down geometric series weights. The spectral components of other frequencies and frames are smoothed in the same way. Further, for time and frequency domain, the different geometric series weights can be used.

FIG. 6B shows the speech spectrum after smoothing. It can be seen that the energy of the speech spectrum after smoothing can be increased in comparison with the energy of the original spectral component with extremely low energy.

Back to FIG. 5, the speech spectrum after smoothing is outputted after the speech spectrum inputted is smoothed with geometric series weights at Step 510.

It can be known from the above description, the original spectral component with extremely low energy can be filled with the energies of neighboring spectral components by smoothing the spectral component with the weight average of energies of its neighboring spectral components according to the method for smoothing a speech spectrum according to the embodiment, thereby the quality of the speech spectrum can be improved.

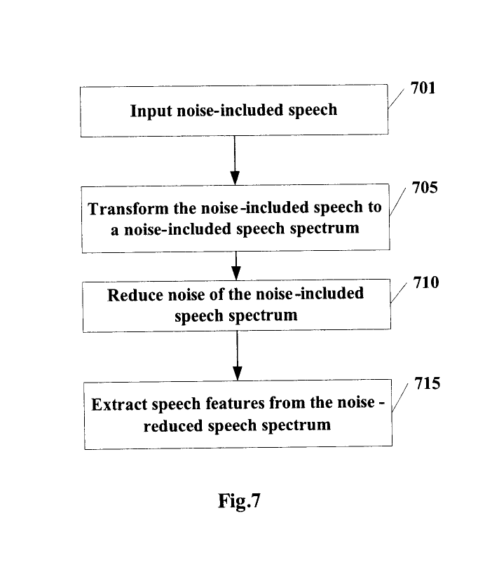

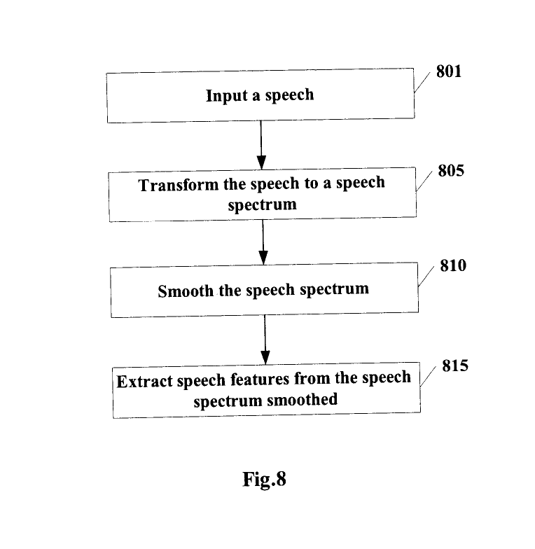

Under the same inventive conception, FIG. 7 is a flowchart showing a method for extracting speech features according to another embodiment of the present invention. Next, the present embodiment will be described in conjunction with FIG. 7. For those same parts as the above embodiments, the description of which will be appropriately omitted.

As shown in FIG. 7, first at Step 701, a noise-included speech which includes a speech from a speaker and background noise is inputted.

Next, at Step 705, the noise-included speech is transformed to a noise-included speech spectrum by, for example, transforming a speech on time domain to a speech spectrum on frequency domain through a Fast Fourier Transform (FFT).

Next, at Step 710, the noise of the noise-included speech spectrum is reduced by the method for noise suppression according to the above-mentioned embodiment in FIGS. 1 and 2. The method for noise suppression performs the minimum mean-square error estimation with the formula (3) and (2), wherein the confluent hyper-geometric function is replaced with a piece-wise linear function. The specific procedure of noise suppression is same as that in the above-mentioned embodiment, and therefore it is omitted herein.

Further, the noise of the noise-included speech spectrum can be reduced by the method for noise suppression according to the above-mentioned embodiment in FIGS. 3 and 4. The method for noise suppression performs the minimum mean-square error estimation with the formula (1) and (4) or formula (3) and (4), wherein a prior signal-noise-rate ξ is replaced with aξ. The specific procedure of noise suppression is same as that in the above-mentioned embodiment, and therefore it is omitted herein.

At last, at Step 715, speech features are extracted from the noise-reduced speech spectrum. Specifically, the speech features can be extracted by conventional methods such as Mel Frequency Cepstral Coefficient (MFCC) or Linear Predictive Cepstral Coefficient (LPCC), etc., and the present invention has no special limitation to this.

It can be known from the above description, since the method for extracting speech features according to the embodiment can perform the minimum mean-square error estimation with the formula (3) and (2) before extracting speech features from the noise-included speech spectrum, wherein the piece-wise linear function is used to replace the confluent hyper-geometric function, the computation load of the MMSE estimation is greatly reduced while the performance of noise reduction is maintained, thereby the quality of speech features can be improved.

Further, the method for extracting speech features according to the embodiment can perform the minimum mean-square error estimation with the formula (1) and (4) before extracting speech features from the noise-included speech spectrum, wherein aξ is used to replace the a prior signal-noise-rate ξ to adjust the a prior signal-noise-rate ξ to control the balance between the noise reduction and the speech distortion, thereby the quality of speech features can be improved.

Further, the embodiment can perform the minimum mean-square error estimation with the formula (3) and (4) to reduce noise, thereby the computation load of the MMSE estimation is greatly reduced while the balance between the noise reduction and the speech distortion is controlled. Accordingly, the quality of speech features can be improved.

Under the same inventive conception, FIG. 8 is a flowchart showing a method for extracting speech features according to another embodiment of the present invention. Next, the present embodiment will be described in conjunction with FIG. 8. For those same parts as the above embodiments, the description of which will be appropriately omitted.

As shown in FIG. 8, first at Step 801, a speech such as a pure speech or a noise-included speech is inputted, and the embodiment has no special limitation to the speech.

Next, at Step 805, the speech is transformed to a speech spectrum by, for example, transforming a speech on time domain to a speech spectrum on frequency domain through a Fast Fourier Transform (FFT). Herein, if the speech includes noise, the noise in the speech spectrum transformed can be suppressed by the method for noise suppression in the above-mentioned embodiment.

Next, at Step 810, the speech spectrum can be smoothed by the above-mentioned methods for smoothing a speech spectrum. Specifically, the speech spectrum can be smoothed by any one of the above-mentioned three smoothing methods, or a combination thereof. The specific procedure for smoothing is same as that in the above-mentioned embodiment, and therefore it is omitted herein.

At last, at Step 815, speech features are extracted from the speech spectrum smoothed. Specifically, the speech features can be extracted by conventional methods such as Mel Frequency Cepstral Coefficient (MFCC) or Linear Predictive Cepstral Coefficient (LPCC), etc., and the present invention has no special limitation to this.

It can be known from the above description, since the method for extracting speech features can fill the original spectral component with extremely low energy with the energies of neighboring spectral components by smoothing the spectral component with the weight average of energies of its neighboring spectral components according to the method for smoothing a speech spectrum according to the embodiment before extracting speech features from the speech spectrum, the quality of the speech spectrum can be improved. Accordingly, the quality of the speech features can be improved.

Further, in the embodiment, if the speech includes noise, the noise can be reduced by performing the minimum mean-square error estimation with the formula (3) and (2) by using the method for noise suppression according to the embodiment of FIGS. 1 and 2, wherein the piece-wise linear function is used to replace the confluent hyper-geometric function, thereby the computation load of the MMSE estimation is greatly reduced while the performance of noise reduction is maintained, and the quality of speech features can be improved.

Further, in the embodiment, if the speech includes noise, the noise can be reduced by performing the minimum mean-square error estimation with the formula (1) and (4) by using the method for noise suppression according to the embodiment of FIGS. 3 and 4, wherein aξ is used to replace the a prior signal-noise-rate ξ to adjust the a prior signal-noise-rate ξ to control the balance between the noise reduction and the speech distortion, thereby the quality of speech features can be improved.

Further, the embodiment can perform the minimum mean-square error estimation with the formula (3) and (4), thereby the computation load of MMSE estimation is greatly reduced while the balance between the noise reduction and the speech distortion can be controlled. Accordingly, the quality of speech features can be improved.

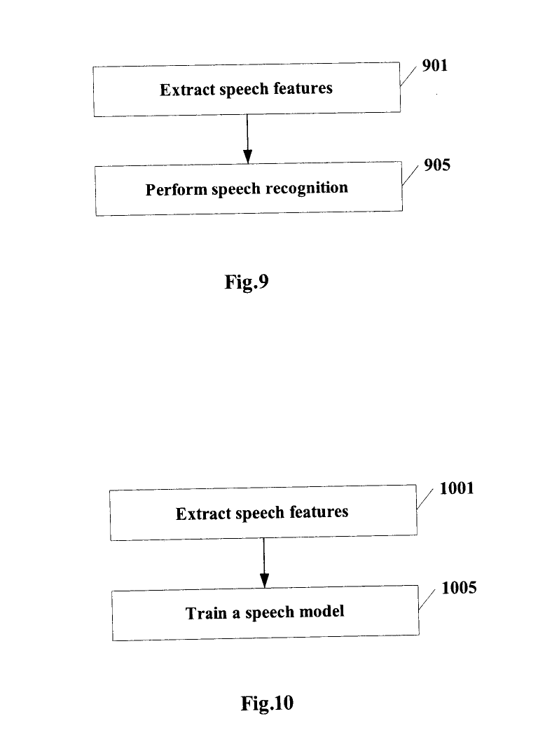

Under the same inventive conception, FIG. 9 is a flowchart showing a method of speech recognition according to another embodiment of the present invention. Next, the present embodiment will be described in conjunction with FIG. 9. For those same parts as the above embodiments, the description of which will be appropriately omitted.

As shown in FIG. 9, first at Step 901, speech features are extracted by using the above-mentioned method for extracting speech features according to the embodiment of FIG. 7 or 8. The specific procedure of extracting is same as that in the above-mentioned embodiment, and therefore it is omitted herein.

Next, at Step 905, speech recognition is performed according to the speech features extracted. Specifically, for example, the speech features extracted can be compared with the formerly trained template to recognize the content information of the speech, and the invention has no limitation to this.

It can be known from the above description, in the method of speech recognition according to the embodiment, the original spectral component with extremely low energy can be filled with the energies of neighboring spectral components by smoothing the spectral component with the weight average of energies of its neighboring spectral components according to the method for smoothing a speech spectrum according to the embodiment before extracting speech features from the speech spectrum, thereby the quality of the speech spectrum can be improved. Accordingly, the performance of the speech recognition can be improved.

Further, in the embodiment, if the speech includes noise, the noise can be reduced by performing the minimum mean-square error estimation with the formula (3) and (2), wherein the piece-wise linear function is used to replace the confluent hyper-geometric function before extracting speech features from the noise-included speech spectrum, thereby the computation load of the MMSE estimation is greatly reduced while the performance of noise reduction is maintained, and the performance of the speech recognition can be improved.

Further, optionally, the method of speech recognition according to the embodiment can reduce noise by performing the minimum mean-square error estimation with the formula (1) and (4), wherein aξ is used to replace the a prior signal-noise-rate ξ to adjust the a prior signal-noise-rate ξ to control the balance between the noise reduction and the speech distortion before extracting speech features from the noise-included speech spectrum, thereby the performance of the speech recognition can be improved.

Further, the embodiment can perform the minimum mean-square error estimation with the formula (3) and (4), thereby the computation load of MMSE estimation is greatly reduced while the balance between the noise reduction and the speech distortion can be controlled. Accordingly, the performance of the speech recognition can be improved.

Under the same inventive conception, FIG. 10 is a flowchart showing a method for training a speech model according to another embodiment of the present invention. Next, the present embodiment will be described in conjunction with FIG. 10. For those same parts as the above embodiments, the description of which will be appropriately omitted.

As shown in FIG. 10, first at Step 1001, speech features are extracted by using the above-mentioned method for extracting speech features according to the embodiment of FIG. 7 or 8. The specific procedure of extracting is same as that in the above-mentioned embodiment, and therefore it is omitted herein.

Next, at Step 1005, the speech model is trained according to the speech features extracted.

It can be known from the above description, in the method of speech recognition according to the embodiment, the original spectral component with extremely low energy can be filled with the energies of neighboring spectral components by smoothing the spectral component with the weight average of energies of its neighboring spectral components according to the method for smoothing a speech spectrum according to the embodiment before extracting speech features from the speech spectrum, thereby the quality of the speech spectrum can be improved. Accordingly, the quality of the speech model trained can be improved.

Further, in the embodiment, if the speech includes noise, the noise can be reduced by performing the minimum mean-square error estimation with the formula (3) and (2), wherein the piece-wise linear function is used to replace the confluent hyper-geometric function, thereby the computation load of the MMSE estimation is greatly reduced while the performance of noise reduction is maintained, and the quality of the speech model trained can be improved.

Further, optionally, the method of training a speech model according to the embodiment can reduce noise by performing the minimum mean-square error estimation with the formula (1) and (4), wherein aξ is used to replace the a prior signal-noise-rate ξ to adjust the a prior signal-noise-rate ξ to control the balance between the noise reduction and the speech distortion before extracting speech features from the noise-included speech spectrum, thereby the quality of the speech model trained can be improved.

Further, the method of training a speech model according to the embodiment can perform the minimum mean-square error estimation with the formula (3) and (4), thereby the computation load of MMSE estimation is greatly reduced while the balance between the noise reduction and the speech distortion can be controlled. Accordingly, the quality of the speech model trained can be improved.

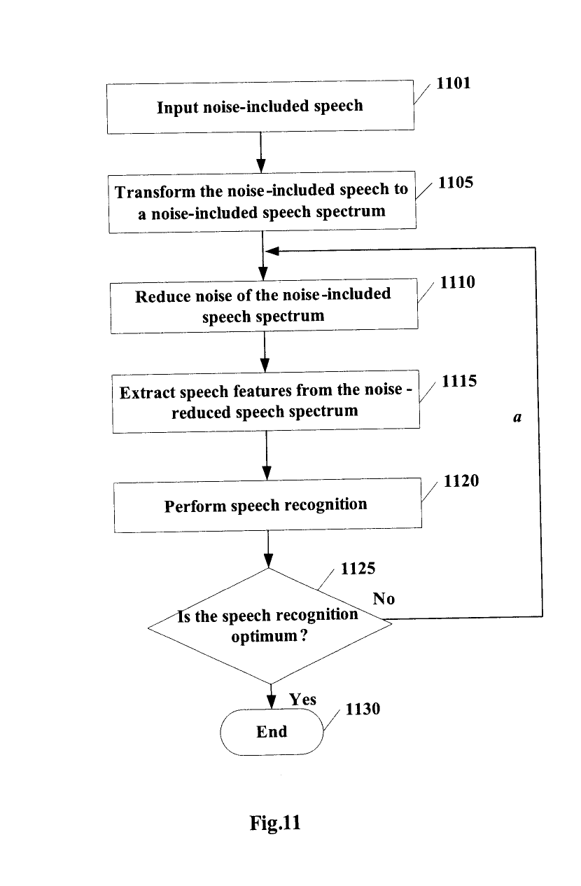

Under the same inventive conception, FIG. 11 is a flowchart showing a method of speech recognition according to another embodiment of the present invention. Next, the present embodiment will be described in conjunction with FIG. 11. For those same parts as the above embodiments, the description of which will be appropriately omitted.

As shown in FIG. 11, first at Step 1101, a noise-included speech which includes a speech from a speaker and background noise is inputted.

Next, at Step 1105, the noise-included speech is transformed to a noise-included speech spectrum by, for example, transforming a speech on time domain to a speech spectrum on frequency domain through a Fast Fourier Transform (FFT).

Next, at Step 1110, the noise of the noise-included speech spectrum is reduced by the method for noise suppression according to the above-mentioned embodiment of FIGS. 3 and 4. The method for noise suppression performs the minimum mean-square error estimation with the formula (1) and (4) or formula (3) and (4). The specific procedure of noise suppression is same as that in the above-mentioned embodiment, and therefore it is omitted herein.

Next, at Step 1115, speech features are extracted from the noise-reduced speech spectrum. Specifically, the speech features can be extracted by conventional methods such as Mel Frequency Cepstral Coefficient (MFCC) or Linear Predictive Cepstral Coefficient (LPCC), etc., and the present invention has no special limitation to this.

Next, at Step 1120, the speech is recognized according to the speech features extracted. Specifically, for example, the speech features extracted can be compared with the formerly trained template to recognize the content information of the speech, and the invention has no limitation to this.

Next, at Step 1125, it is determined whether the result of speech recognition is optimum according to the correct ratio of recognition, that is to determine whether the correct ratio is bigger than a pre-determined threshold, and if it is optimum, the process is finished at Step 1130. If not, the coefficient a is adjusted according to the result of speech recognition, and the process will be back to Step 1110 to continue MMSE estimation until a satisfactory result is obtained. The specific procedure of adjusting is same as that in the above-mentioned embodiment of FIGS. 3 and 4, and therefore it is omitted herein.

It can be known from the above description, the performance of speech recognition can be improved since the method of speech recognition according to the embodiment can effectively adjust MMSE estimation according to the result of speech recognition.

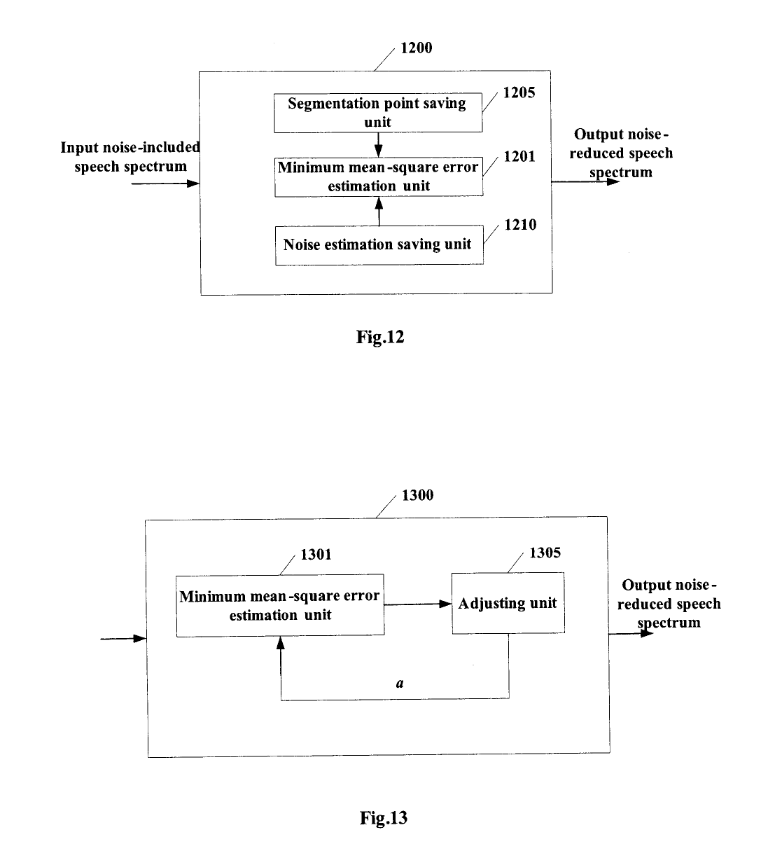

Under the same inventive conception, FIG. 12 is a block diagram showing an apparatus of noise suppression according to an embodiment of the present invention. Next, the present embodiment will be described in conjunction with FIG. 12. For those same parts as the above embodiments, the description of which will be appropriately omitted.

As shown in FIG. 12, the apparatus 1200 of noise suppression for a noise-included speech spectrum according to the embodiment comprises a minimum mean-square error estimation unit 1201 configured to perform minimum mean-square error estimation on the noise-included speech spectrum with a noise estimation spectrum to reduce noise of said noise-included speech spectrum. The minimum mean-square error estimation unit 1201 performs minimum mean-square error estimation with the formula (3) and (2) by replacing the confluent hyper-geometric function with a piece-wise linear function. The specific detail is same as the method for noise suppression according to the embodiment of FIGS. 1 and 2, and therefore it is omitted herein.

The apparatus 1200 of noise suppression according to the embodiment further comprises a segmentation point saving unit 1205 configured to save the segmentation points of the piece-wise linear function; a noise estimation saving unit 1210 configured to save the noise estimation obtained from the pre-estimation on the background noise. Further, the noise estimation can be inputted to the minimum mean-square error estimation unit 1201 from outside.

It can be known from the above description, since the apparatus 1200 of noise suppression according to the embodiment uses the piece-wise linear function to replace the confluent hyper-geometric function, the computation load of MMSE estimation is greatly reduced while the performance of noise reduction is maintained.

Under the same inventive conception, FIG. 13 is a block diagram showing an apparatus of noise suppression according to another embodiment of the present invention. Next, the present embodiment will be described in conjunction with FIG. 13. For those same parts as the above embodiments, the description of which will be appropriately omitted.

As shown in FIG. 13, the apparatus 1300 of noise suppression for a noise-included speech spectrum according to the embodiment comprises a minimum mean-square error estimation unit 1301 configured to perform minimum mean-square error estimation on the noise-included speech spectrum with an a priori signal-noise-rate to reduce noise of said noise-included speech spectrum; and an adjusting unit 1305 configured to adjust the a priori signal-noise-rate to obtain proper noise suppression. The specific detail is same as the method for noise suppression according to the embodiment of FIGS. 3 and 4, and therefore it is omitted herein.

It can be known from the above description, the balance between the noise reduction and the speech distortion can be controlled because the apparatus 1300 of noise suppression according to the embodiment can adjust the a prior signal-noise-rate, thereby a satisfactory result can be obtained.

Further, the apparatus 1300 of noise suppression according to the embodiment can perform the minimum mean-square error estimation by using the piece-wise linear function to replace the confluent hyper-geometric function, thereby the computation load of MMSE estimation is greatly reduced while the performance of noise reduction is maintained.

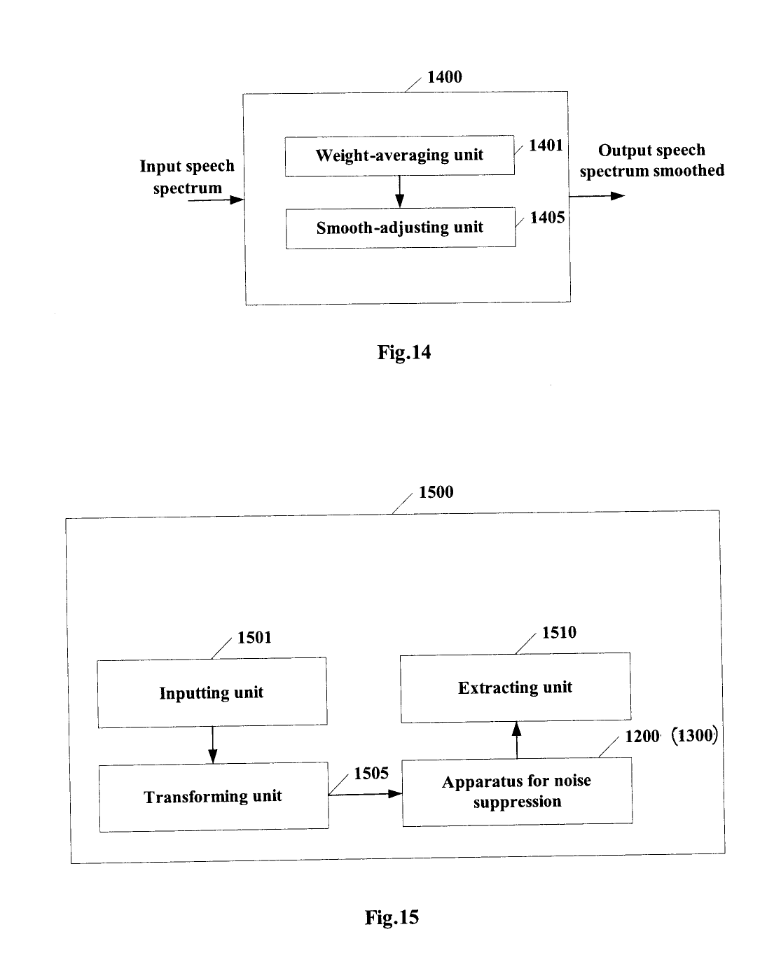

Under the same inventive conception, FIG. 14 is a block diagram showing an apparatus for smoothing a speech spectrum according to another embodiment of the present invention. Next, the present embodiment will be described in conjunction with FIG. 14. For those same parts as the above embodiments, the description of which will be appropriately omitted.

As shown in FIG. 14, the apparatus 1400 for smoothing a speech spectrum according to the embodiment comprises a weight-averaging unit 1401 configured to calculate weight average of energies of each spectral component of the speech spectrum and its neighboring spectral components with geometric series weights; and a smooth-adjusting unit 1405 configured to adjust the energy of the spectral component with the weight average of energies of the spectral component and its neighboring spectral components calculated by the weight-averaging unit. The specific detail is same as the description of the method for smoothing speech according to the embodiment of FIGS. 5 and 6, and therefore it is omitted herein.

It can be known from the above description, the original spectral component with extremely low energy can be filled with the energies of neighboring spectral components by smoothing the spectral component with the weight average of energies of its neighboring spectral components by the apparatus 1400 for smoothing a speech spectrum according to the embodiment, thereby the quality of the speech spectrum is improved.

Under the same inventive conception, FIG. 15 is a block diagram showing an apparatus for extracting speech features according to another embodiment of the present invention. Next, the present embodiment will be described in conjunction with FIG. 15. For those same parts as the above embodiments, the description of which will be appropriately omitted.

As shown in FIG. 15, the apparatus 1500 for extracting speech features according to the embodiment comprises an inputting unit 1501 configured to input a noise-included speech; a transforming unit 1505 configured to transform a noise-included speech to a noise-included speech spectrum; the above-mentioned apparatus 1200 of noise suppression or apparatus 1300 of noise suppression configured to reduce noise of the noise-included speech spectrum; and an extracting unit 1510 configured to extract speech features from the noise-reduced speech spectrum. The specific detail is same as the description of the method for extracting speech features according to the embodiment of FIG. 7, and therefore it is omitted herein.

It can be known from the above description, since the apparatus 1500 for extracting speech features according to the embodiment can perform the minimum mean-square error estimation with the formula (3) and (2), wherein the piece-wise linear function is used to replace the confluent hyper-geometric function, the computation load of the MMSE estimation is greatly reduced while the performance of noise reduction is maintained, thereby the quality of speech features can be improved.

Further, optionally, the apparatus 1300 of noise suppression of the apparatus 1500 for extracting speech features according to the embodiment can perform the minimum mean-square error estimation with the formula (1) and (4), wherein aξ is used to replace the a prior signal-noise-rate ξ to adjust the a prior signal-noise-rate ξ to control the balance between the noise reduction and the speech distortion, thereby the quality of speech features can be improved.

Further, the apparatus 1300 of noise suppression of the apparatus 1500 for extracting speech features according to the embodiment can perform the minimum mean-square error estimation with the formula (3) and (4) to reduce noise, thereby the computation load of the MMSE estimation is greatly reduced while the balance between the noise reduction and the speech distortion is controlled. Accordingly, the quality of speech features can be improved.

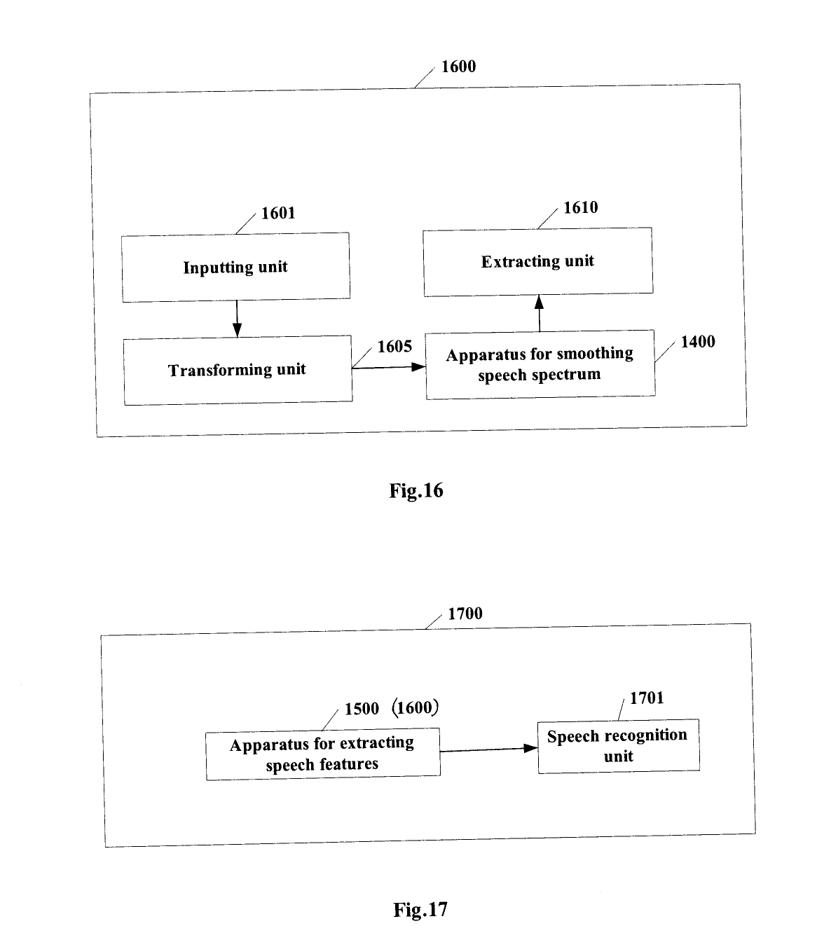

Under the same inventive conception, FIG. 16 is a block diagram showing an apparatus for extracting speech features according to another embodiment of the present invention. Next, the present embodiment will be described in conjunction with FIG. 16. For those same parts as the above embodiments, the description of which will be appropriately omitted.

As shown in FIG. 16, the apparatus 1600 for extracting speech features according to the embodiment comprises an inputting unit 1601 configured to input a speech; a transforming unit 1605 configured to transform the speech to a speech spectrum; the above-mentioned apparatus 1400 for smoothing a speech spectrum configured to smooth the speech spectrum; and an extracting unit 1610 configured to extract speech features from the speech spectrum smoothed. The specific detail is same as the description of the method for extracting speech features according to the embodiment of FIG. 8, and therefore it is omitted herein.

It can be known from the above description, since the apparatus 1500 for extracting speech features according to the embodiment can fill the original spectral component with extremely low energy with the energies of neighboring spectral components by smoothing the spectral component with the weight average of energies of its neighboring spectral components according to the method for smoothing a speech spectrum according to the embodiment, the quality of the speech spectrum can be improved. Accordingly, the quality of the speech features can be improved.

Further, in the embodiment, if the speech includes noise, the noise can be reduced by performing the minimum mean-square error estimation with the formula (3) and (2) by using the method for noise suppression according to the embodiment of FIGS. 1 and 2, wherein the piece-wise linear function is used to replace the confluent hyper-geometric function, thereby the computation load of the MMSE estimation is greatly reduced while the performance of noise reduction is maintained, and the quality of speech features can be improved.

Further, in the embodiment, if the speech includes noise, the noise can be reduced by performing the minimum mean-square error estimation with the formula (1) and (4) by using the method for noise suppression according to the embodiment of FIGS. 3 and 4, wherein aξ is used to replace the a prior signal-noise-rate ξ to adjust the a prior signal-noise-rate ξ to control the balance between the noise reduction and the speech distortion, thereby the quality of speech features can be improved.

Further, the embodiment can perform the minimum mean-square error estimation with the formula (3) and (4), thereby the computation load of MMSE estimation is greatly reduced while the balance between the noise reduction and the speech distortion can be controlled. Accordingly, the quality of speech features can be improved.

Under the same inventive conception, FIG. 17 is a block diagram showing an apparatus of speech recognition according to another embodiment of the present invention. Next, the present embodiment will be described in conjunction with FIG. 17. For those same parts as the above embodiments, the description of which will be appropriately omitted.

As shown in FIG. 17, the apparatus 1700 of speech recognition according to the embodiment comprises the apparatus 1500 or 1600 for extracting speech features configured to extract speech features; and a speech recognition unit 1701 configured to recognize the speech based on the speech features extracted. The specific detail is same as the description of the method of speech recognition according to the embodiment of FIG. 9, and therefore it is omitted herein.

It can be known from the above description, the apparatus 1700 of speech recognition according to the embodiment can fill the original spectral component with extremely low energy with the energies of neighboring spectral components by smoothing the spectral component with the weight average of energies of its neighboring spectral components according to the method for smoothing a speech spectrum according to the embodiment, thereby the quality of the speech spectrum can be improved. Accordingly, the performance of the speech recognition can be improved.

Further, in the embodiment, if the speech includes noise, the noise can be reduced by performing the minimum mean-square error estimation with the formula (3) and (2), wherein the piece-wise linear function is used to replace the confluent hyper-geometric function before extracting speech features from the noise-included speech spectrum, thereby the computation load of the MMSE estimation is greatly reduced while the performance of noise reduction is maintained, and the performance of the speech recognition can be improved.

Further, optionally, the apparatus 1700 of speech recognition according to the embodiment can reduce noise by performing the minimum mean-square error estimation with the formula (1) and (4), wherein aξ is used to replace the a prior signal-noise-rate ξ to adjust the a prior signal-noise-rate ξ to control the balance between the noise reduction and the speech distortion before extracting speech features from the noise-included speech spectrum, thereby the performance of the speech recognition can be improved.

Further, the apparatus 1700 of speech recognition according to the embodiment can perform the minimum mean-square error estimation with the formula (3) and (4), thereby the computation load of MMSE estimation is greatly reduced while the balance between the noise reduction and the speech distortion can be controlled. Accordingly, the performance of the speech recognition can be improved.

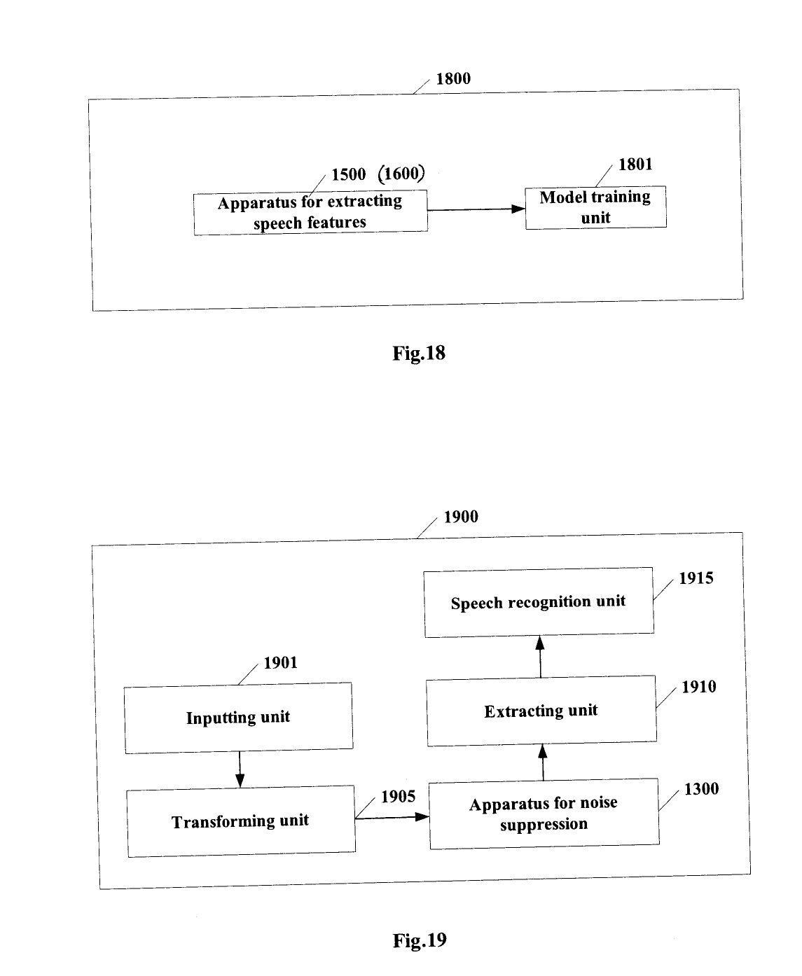

Under the same inventive conception, FIG. 18 is a block diagram showing an apparatus for training a speech model according to another embodiment of the present invention. Next, the present embodiment will be described in conjunction with FIG. 18. For those same parts as the above embodiments, the description of which will be appropriately omitted.

As shown in FIG. 18, the apparatus 1800 for training a speech model according to the embodiment comprises the apparatus 1500 or 1600 for extracting speech features configured to extract speech features; and a model-training unit 1801 configured to train said speech model based on said speech features extracted. The specific detail is same as the description of the method of speech recognition according to the embodiment of FIG. 10, and therefore it is omitted herein.

It can be known from the above description, the apparatus 1800 for training a speech model according to the embodiment can fill the original spectral component with extremely low energy with the energies of neighboring spectral components by smoothing the spectral component with the weight average of energies of its neighboring spectral components according to the method for smoothing a speech spectrum according to the embodiment before extracting speech features from the speech spectrum, thereby the quality of the speech spectrum can be improved. Accordingly, the quality of the speech model trained can be improved.

Further, in the embodiment, if the speech includes noise, the noise can be reduced by performing the minimum mean-square error estimation with the formula (3) and (2), wherein the piece-wise linear function is used to replace the confluent hyper-geometric function, thereby the computation load of the MMSE estimation is greatly reduced while the performance of noise reduction is maintained, and the quality of the speech model trained can be improved.

Further, optionally, the apparatus 1800 for training a speech model according to the embodiment can reduce noise by performing the minimum mean-square error estimation with the formula (1) and (4), wherein aξ is used to replace the a prior signal-noise-rate ξ to adjust the a prior signal-noise-rate ξ to control the balance between the noise reduction and the speech distortion before extracting speech features from the noise-included speech spectrum, thereby the quality of the speech model trained can be improved.

Further, the apparatus 1800 for training a speech model according to the embodiment can perform the minimum mean-square error estimation with the formula (3) and (4), thereby the computation load of MMSE estimation is greatly reduced while the balance between the noise reduction and the speech distortion can be controlled. Accordingly, the quality of the speech model trained can be improved.

Under the same inventive conception, FIG. 19 is a block diagram showing an apparatus of speech recognition according to another embodiment of the present invention. Next, the present embodiment will be described in conjunction with FIG. 19. For those same parts as the above embodiments, the description of which will be appropriately omitted.

As shown in FIG. 19, the apparatus 1900 of speech recognition according to the embodiment comprises an inputting unit 1901 configured to input a noise-included speech; a transforming unit 1905 configured to transform the noise-included speech to a noise-included speech spectrum; the above-mentioned apparatus 1300 of noise suppression configured to reduce noise of the noise-included speech spectrum; an extracting unit 1910 configured to extract speech features from the noise-reduced speech spectrum; and a speech recognition unit 1915 configured to recognize the speech based on the speech features extracted, wherein an optimum value of the a priori signal-noise-rate is determined according to the result of speech recognition. The specific detail is same as the description of the method of speech recognition according to the embodiment of FIG. 11, and therefore it is omitted herein.

It can be known from the above description, the performance of speech recognition can be improved since the apparatus 1900 of speech recognition according to the embodiment can effectively adjust MMSE estimation according to the result of speech recognition.

Though a method of noise suppression, a method for smoothing a speech spectrum, a method for extracting speech features, a method of speech recognition, and a method for training a speech model; and an apparatus of noise suppression, an apparatus for smoothing a speech spectrum, an apparatus for extracting speech features, an apparatus of speech recognition, and an apparatus for training a speech model have been described in details with some exemplary embodiments, these above embodiments are not exhaustive. Those skilled in the art may make various variations and modifications within the spirit and scope of the present invention. Therefore, the present invention is not limited to these embodiments; rather, the scope of the present invention is only defined by the appended claims.

1. A method of noise suppression for a noise-included speech spectrum, comprising:
performing minimum mean-square error estimation on said noise-included speech spectrum with a noise estimation spectrum, to reduce noise of said noise-included speech spectrum;
wherein the confluent hyper-geometric function is replaced with a piece-wise linear function to perform said minimum mean-square error estimation.

2. The method according to claim 1, wherein said confluent hyper-geometric function is transformed to said piece-wise linear function to perform said minimum mean-square error estimation with a plurality of preset segmentation points.

3. The method according to claim 2, wherein said plurality of preset segmentation points for said piece-wise linear function are obtained by steps of:
calculating a derivative of said confluent hyper-geometric function;
setting a plurality of initial segmentation points for said piece-wise linear function;
calculating a difference between said piece-wise linear function and said confluent hyper-geometric function in between each two consecutive segmentation points of said plurality of initial segmentation points;
inserting a new segmentation point between said tow consecutive segmentation points if said difference is greater than a threshold; and
repeating said step of calculating and said step thereafter until no said difference is greater than said threshold.

4. The method according to any one of claims 1-3, wherein said minimum mean-square error estimation is performed based on the following formula,
$$\begin{matrix}{\hat{A}}_{k} = C \frac{\sqrt{{υ}_{k}}}{{γ}_{k}} L ( {υ}_{k} ) {R}_{k} , wherein \\ {υ}_{k} = \frac{{ξ}_{k}}{1 + {ξ}_{k}} {γ}_{k} ,\end{matrix}$$
wherein Âₖ denotes said noise-reduced speech spectrum, Rₖ denotes said noise-included speech spectrum, C denotes a constant, ξₖ denotes an a priori signal-noise-rate obtained from said noise estimation spectrum, γₖ denotes an a posteriori signal-noise-rate obtained from said noise estimation spectrum and said noise-included speech spectrum, L(υₖ) denotes said piece-wise linear function, and k denotes the kth spectral component.

5. A method of noise suppression for a noise-included speech spectrum, comprising:
performing minimum mean-square error estimation on said noise-included speech spectrum with an a priori signal-noise-rate to reduce noise of said noise-included speech spectrum; and
adjusting said a priori signal-noise-rate to obtain proper noise suppression.

6. The method according to claim 5, wherein said a priori signal-noise-rate is obtained from a noise estimation spectrum.

7. The method according to claim 5 or 6, wherein said step of adjusting increases said a priori signal-noise-rate to decrease said noise suppression or decreases said a priori signal-noise-rate to increase said noise suppression.

8. The method according to any one of claims 5-7, wherein the confluent hyper-geometric function is replaced with a piece-wise linear function to perform said minimum mean-square error estimation.

9. The method according to claim 8, wherein said confluent hyper-geometric function is transformed to said piece-wise linear function to perform said minimum mean-square error estimation with a plurality of preset segmentation points.

10. The method according to claim 9, wherein said plurality of preset segmentation points for said piece-wise linear function are obtained by steps of:
calculating a derivative of said confluent hyper-geometric function;
setting a plurality of initial segmentation points for said piece-wise linear function;
calculating a difference between said piece-wise linear function and said confluent hyper-geometric function in between each two consecutive segmentation points of said plurality of initial segmentation points;
inserting a new segmentation point between said tow consecutive segmentation points if said difference is greater than a threshold; and
repeating said step of calculating and said step thereafter until no said difference is greater than said threshold.

11. The method according to any one of claims 8-10, wherein said minimum mean-square error estimation is performed based on the following formula,
$$\begin{matrix}{\hat{A}}_{k} = C \frac{\sqrt{{υ}_{k}}}{{γ}_{k}} L ( {υ}_{k} ) {R}_{k} , wherein \\ {υ}_{k} = \frac{{ξ}_{k}}{1 + {ξ}_{k}} {γ}_{k} ,\end{matrix}$$
wherein Âₖ denotes said noise-reduced speech spectrum, Rₖ denotes said noise-included speech spectrum, C denotes a constant, ξₖ denotes an a priori signal-noise-rate obtained from said noise estimation spectrum, γₖ denotes an a posteriori signal-noise-rate obtained from said noise estimation spectrum and said noise-included speech spectrum, L(υₖ) denotes said piece-wise linear function, and k denotes the kth spectral component.

12. A method for smoothing a speech spectrum, comprising:
calculating a weight average of energies of each spectral component of said speech spectrum and its neighboring spectral components with geometric series weights; and
adjusting the energy of said spectral component with said weight average calculated.

13. The method according to claim 12, wherein the weight of said geometric series weights at said spectral component is highest, and said geometric series weights decreases in a direction away from said spectral component by said geometric series.

14. The method according to claim 12 or 13, wherein said step of calculating comprises: calculating a weight average of energies of said spectral component and its time-neighboring spectral components of the same frequency with geometric series weights.

15. The method according to claim 12 or 13, wherein said step of calculating comprises: calculating a weight average of energies of said spectral component and its frequency-neighboring spectral components of the same frame with geometric series weights.

16. The method according to claim 12 or 13, wherein said step of calculating comprises: calculating a weight average of energies of said spectral component, its time-neighboring spectral components of the same frequency and its frequency-neighboring spectral components of the same frame with geometric series weights.

17. The method according to any one of claims 12-16, further comprising reducing noise of said speech spectrum by using the method according to any one of claims 1-11 before said step of calculating.

18. A method for extracting speech features, comprising:
transforming a noise-included speech to a noise-included speech spectrum;
reducing noise of said noise-included speech spectrum by using the method of noise suppression according to any one of claims 1-11; and
extracting speech features from said noise-reduced speech spectrum.

19. The method according to claim 18, wherein said step of transforming is performed by fast Fourier transform.

20. A method for extracting speech features, comprising:
transforming a speech to a speech spectrum;
smoothing said speech spectrum by using the method for smoothing a speech spectrum according to any one of claims 12-17; and
extracting speech features from said smoothed speech spectrum.

21. The method according to claim 20, wherein said step of transforming is performed by fast Fourier transform.

22. A method of speech recognition, comprising:
extracting speech features from a speech by using the method for extracting speech features according to any one of claims 18-21; and
recognizing the speech based on said speech features extracted.

23. A method for training a speech model, comprising:
extracting speech features from a speech by using the method for extracting speech features according to any one of claims 18-21; and
training said speech model based on said speech features extracted.

24. A method of speech recognition, comprising:
transforming a noise-included speech to a noise-included speech spectrum;
reducing noise of said noise-included speech spectrum by using the method of noise suppression according to any one of claims 5-11; and
extracting said speech features from said noise-reduced speech spectrum; and
recognizing said noise-included speech based on said speech features extracted;
determining an optimum value of said a priori signal-noise-rate based on the result of speech recognition.

25. An apparatus of noise suppression for a noise-included speech spectrum, comprising:
an estimation unit configured to perform minimum mean-square error estimation on said noise-included speech spectrum with a noise estimation spectrum to reduce noise of said noise-included speech spectrum;
wherein the estimation unit is configured to replace a confluent hyper-geometric function with a piece-wise linear function to perform said minimum mean-square error estimation.

26. The apparatus according to claim 25, wherein said confluent hyper-geometric function is transformed to said piece-wise linear function to perform said minimum mean-square error estimation with a plurality of preset segmentation points.

27. The apparatus according to claim 25 or 26, wherein said minimum mean-square error estimation is performed based on the following formula,
$$\begin{matrix}{\hat{A}}_{k} = C \frac{\sqrt{{υ}_{k}}}{{γ}_{k}} L ( {υ}_{k} ) {R}_{k} , wherein \\ {υ}_{k} = \frac{{ξ}_{k}}{1 + {ξ}_{k}} {γ}_{k} ,\end{matrix}$$
wherein Âₖ denotes said noise-reduced speech spectrum, Rₖ denotes said noise-included speech spectrum, C denotes a constant, ξₖ denotes an a priori signal-noise-rate obtained from said noise estimation spectrum, γₖ denotes an a posteriori signal-noise-rate obtained from said noise estimation spectrum and said noise-included speech spectrum, L(υₖ) denotes said piece-wise linear function, and k denotes the kth spectral component.

28. An apparatus of noise suppression for a noise-included speech spectrum, comprising:
an estimation unit configured to perform minimum mean-square error estimation on said noise-included speech spectrum with an a priori signal-noise-rate to reduce noise of said noise-included speech spectrum; and
an adjusting unit configured to adjust said a priori signal-noise-rate to obtain proper noise suppression.

29. The apparatus according to claim 28, wherein said a priori signal-noise-rate is obtained from a noise estimation spectrum.

30. The apparatus according to claim 28 or 29, wherein said adjusting unit is configured to increase said a priori signal-noise-rate to decrease said noise suppression, or decrease said a priori signal-noise-rate to increase said noise suppression.

31. The apparatus according to any one of claims 28-30, wherein said estimation unit is configured to perform said minimum mean-square error estimation with replacing a confluent hyper-geometric function with a piece-wise linear function.

32. The apparatus according to claim 31, wherein said estimation unit transforms said confluent hyper-geometric function to said piece-wise linear function to perform said minimum mean-square error estimation with a plurality of preset segmentation points.

33. The apparatus of noise suppression according to claim 31 or 32, wherein said estimation unit is configured to perform said minimum mean-square error estimation based on the following formula,
$$\begin{matrix}{\hat{A}}_{k} = C \frac{\sqrt{{υ}_{k}}}{{γ}_{k}} L ( {υ}_{k} ) {R}_{k} , wherein \\ {υ}_{k} = \frac{{ξ}_{k}}{1 + {ξ}_{k}} {γ}_{k} ,\end{matrix}$$
wherein Âₖ denotes said noise-reduced speech spectrum, Rₖ denotes said noise-included speech spectrum, C denotes a constant, ξₖ denotes an a priori signal-noise-rate obtained from said noise estimation spectrum, γₖ denotes an a posteriori signal-noise-rate obtained from said noise estimation spectrum and said noise-included speech spectrum, L(υₖ) denotes said piece-wise linear function, and k denotes the kth spectral component.

34. An apparatus for smoothing a speech spectrum, comprising:
a weight-averaging unit configured to calculate weight average of energies of each spectral component of said speech spectrum and its neighboring spectral components with geometric series weights; and
a smooth-adjusting unit configured to adjust the energy of said spectral component with said weight average of energies of said spectral component and its neighboring spectral components calculated by said weight-averaging unit.

35. The apparatus according to claim 34, wherein the weight of said geometric series weights at said spectral component is highest, and said geometric series weights decreases in a direction away from said spectral component by a geometric series.

36. The apparatus according to claim 34 or 35, wherein said weight-averaging unit is further configured to calculate a weight average of energies of said spectral component and its time-neighboring spectral components of the same frequency with geometric series weights.

37. The apparatus according to claim 34 or 35, wherein said weight-averaging unit is further configured to calculate a weight average of energies of said spectral component and its frequency-neighboring spectral components of the same frame with geometric series weights.

38. The apparatus according to claim 34 or 35, wherein said weight-averaging unit is configured to calculate a weight average of energies of said spectral component, its time-neighboring spectral components of the same frequency and its frequency-neighboring spectral components of the same frame with geometric series weights.

39. The apparatus according to any one of claims 34-38, further comprising the apparatus according to any one of claims 25-33 configured to reduce noise of said speech spectrum before said step of calculating weight average.

40. An apparatus for extracting speech features, comprising:
a transforming unit configured to transform a noise-included speech to a noise-included speech spectrum;
the apparatus of noise suppression according to any one of claims 25-33 configured to reduce noise of said noise-included speech spectrum; and
an extracting unit configured to extract speech features from said noise-reduced speech spectrum.

41. The apparatus according to claim 40, wherein said transforming unit is configured to transform by a fast Fourier transform.

42. An apparatus for extracting speech features, comprising:
a transforming unit configured to transform a speech to a speech spectrum;
the apparatus for smoothing a speech spectrum according to any one of claims 34-39 configured to smooth said speech spectrum; and
an extracting unit configured to extract speech features from said smoothed speech spectrum.

43. The apparatus according to claim 42, wherein said transforming unit is configured to transform by a fast Fourier transform.

44. A apparatus of speech recognition, comprising:
the apparatus for extracting speech features according to any one of claims 40-43 configured to extract speech features; and
a speech recognition unit configured to recognize the speech based on said speech features extracted.

45. A apparatus for training a speech model, comprising:
the apparatus according to any one of claims 40-43 configured to extract speech features; and
a model-training unit configured to train said speech model based on said speech features extracted.

46. A apparatus of speech recognition, comprising:
a transforming unit configured to transform a noise-included speech to a noise-included speech spectrum;
the apparatus of noise suppression according to any one of claims 28-33 configured to reduce noise of said noise-included speech spectrum; and
an extracting unit configured to extract speech features from said noise-reduced speech spectrum;
a speech recognition unit configured to recognize said noise-included speech based on said speech features extracted; and
a determination unit configured to determine an optimum value of said a priori signal-noise-rate according to the result of speech recognition.
